(19) United States
(12) Patent Application Publication
(10) Pub. No.: US 2018/0244221 A1
(43) Pub. Date: Aug. 30, 2018

(54) IN-VEHICLE POWER SUPPLY APPARATUS

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Akio Ishihara, Yokkaichi, Mie (JP)

(21) Appl. No.: 15/755,265

(22) PCT Filed: Aug. 22, 2016
(86) PCT No.: PCT/JP2016/074350

§ 371 Date: Feb. 26, 2018

(30) Foreign Application Priority Data
Sep. 11, 2015 (JP) 2015-179487

(51) Int. Cl. B60R 16/033; B60L 7/22; B60R 16/04; H01M 10/44; H01M 10/48; H02J 7/16; H02J 7/34

(52) U.S. Cl. CPC B60R 16/033; B60L 7/22; B60R 16/04; H02J 7/34; H01M 10/48; H02J 7/16; H01M 10/44

(57) ABSTRACT

Provided is a vehicle power supply apparatus that is capable of charging power storage devices for regeneration and for auxiliary use with respectively suitable voltages, and that is able to reduce manufacturing cost. A first power storage device is charged via a bidirectional converter and discharges to a load via the converter. A first switch selects on/off between the converter and the first power storage device. A second power storage device is charged via the converter and discharges to the load through a path that bypasses the converter. A second switch selects on/off between the converter and the second power storage device.

### CROSS-REFERENCE TO RELATED APPLICATIONS

This application is the U.S. national stage of PCT/JP2016/074350 filed Aug. 22, 2016, which claims priority of Japanese Patent Application No. JP 2015-179487 filed Sep. 11, 2015.

### TECHNICAL FIELD

This invention relates to an in-vehicle power supply apparatus.

### BACKGROUND

JP 6-296332A describes a vehicle power supply apparatus having a main power storage means and a reserve power storage means. The reserve power storage means is an electric double-layer capacitor, and charging and discharging thereof are controlled by a DC-DC converter. The DC-DC converter charges the reserve power storage means using power that is generated by an alternator at times when the vehicle is decelerating, and supplies power to a vehicle electrical load at times other than when the vehicle is decelerating.

JP 2009-120159A describes an electric power steering apparatus. An electric motor that supplies a steering assist force is provided in the power steering apparatus, and a main power supply, an auxiliary power supply and a charging/discharging circuit are provided in a motor control apparatus that controls this electric motor. The charging/discharging circuit switches between charging and discharging the auxiliary power supply.

Consideration of what type of configuration to employ in charging the power storage devices in the case where both a power storage device for regeneration and a power storage device for auxiliary use are provided is neither described nor suggested in Patent Documents 1 and 2.

Incidentally, the power storage device for regeneration and the power storage device for auxiliary use are desirably charged with respectively suitable voltages. Also, low manufacturing cost is desirable.

An object of the instant invention is to provide a vehicle power supply apparatus that is capable of charging power storage devices for regeneration and for auxiliary use with respectively suitable voltages, and is able to reduce manufacturing cost.

### SUMMARY

The in-vehicle power supply apparatus is an in-vehicle power supply apparatus to be mounted in a vehicle, and includes a bidirectional converter, a first power storage device that is charged via the converter and discharges to a load via the converter, a first switch that selects on/off between the converter and the first power storage device, a second power storage device that is charged via the converter and discharges to the load through a path that bypasses the converter, and a second switch that selects on/off between the converter and the second power storage device.

According to the in-vehicle power supply apparatus, charging of power storage devices for regeneration and for auxiliary use with respectively suitable voltages is possible, and manufacturing cost can be reduced.

### BRIEF DESCRIPTION OF DRAWINGS

FIG. 1 is a diagram schematically showing an example of the configuration of an in-vehicle power supply apparatus.

FIG. 2 is a diagram schematically showing an example of the configuration of an in-vehicle power supply apparatus.

FIG. 3 is a flowchart showing an example of the operation of a controller.

FIG. 4 is a flowchart showing an example of the operation of a controller.

FIG. 5 is a flowchart showing an example of the operation of a controller.

### DETAILED DESCRIPTION OF PREFERRED EMBODIMENTS

Configuration of in-Vehicle Power Supply

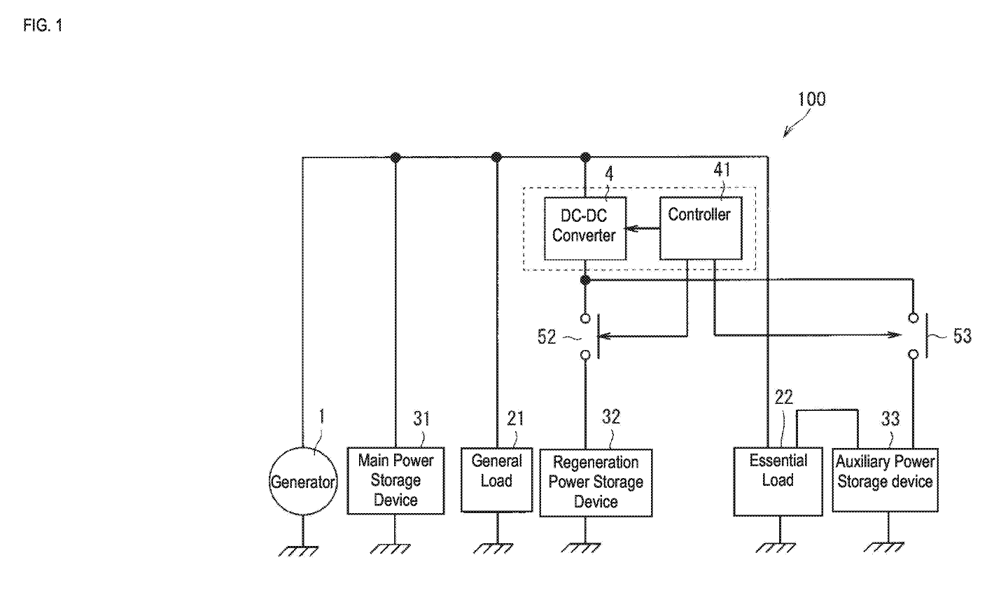

Apparatus FIG. 1 is a diagram schematically showing an example of the configuration of an in-vehicle power supply apparatus 100 that is mounted in a vehicle. In the illustrative example of FIG. 1, a generator 1 is provided. The generator 1 is an alternator, for example, and generates power based on a driving force for driving the vehicle and outputs a direct current (DC) voltage.

In the illustrative example of FIG. 1, a main power storage device 31 is connected to the generator 1. The power storage device 31 is charged by the generator 1. The main power storage device 31 is a lead storage cell or the like, for example.

A power storage device 32 for regeneration (referred to the drawings and the following description as “regeneration power storage device”) is connected to the generator 1 via a bidirectional DC-DC converter 4. In other words, the DC-DC converter 4 is connected between the generator 1 and the regeneration power storage device 32. A capacitor, for example, can be employed for the regeneration power storage device 32.

In the illustrative example of FIG. 1, a switch (e.g., relay) 52 is connected between the DC-DC converter 4 and the regeneration power storage device 32. The switch 52 selects on/off between the DC-DC converter 4 and the regeneration power storage device 32. On/off of the switch 52 is controlled by a controller 41.

The bidirectional DC-DC converter 4 is a buck-boost converter circuit, for example, and controls charging and discharging of the regeneration power storage device 32. The DC-DC converter 4 is controlled by the controller 41.

Note that, here, the controller 41 is configured to include a microcomputer and a storage device. The microcomputer executes processing steps (in other words, procedures) described in computer programs. The storage device can, for example, be constituted by one or a plurality of types of storage devices such as a ROM (Read Only Memory), a RAM (Random Access Memory), a rewritable nonvolatile memory (EPROM (Erasable Programmable ROM), etc.) and a hard disk drive. The storage device stores various types of information, data and the like, stores programs that are to be executed by the microcomputer, and provides a work area for executing the programs. Note that it is comprehensible that the microcomputer functions as various means corresponding to the processing steps described in the programs, or realizes various functions corresponding to the processing steps. Also, the controller 41 is not limited thereto, and the various procedures that are executed by the controller 41 or the various means or various functions that are realized thereby may be partly or entirely realized with hardware.

The DC-DC converter 4 boosts or bucks, as appropriate, the regenerative power that is obtained from the generator 1, or, specifically, the generated DC voltage, at times when the vehicle is decelerating, for example. If the switch 52 is on, the boosted or bucked voltage is output to the regeneration power storage device 32, and the regeneration power storage device 32 is charged. On the other hand, at times when the vehicle is power running, the DC-DC converter 4 discharges the regeneration power storage device 32. For example, at times when the vehicle is power running, the regeneration power storage device 32 is discharged, by boosting or bucking, as appropriate, the DC voltage of the regeneration power storage device 32 that is input via the switch 52, and outputting the resultant voltage to a general load 21 and an essential load 22 which will be discussed later.

A power storage device 33 for auxiliary use (referred to in the drawings and the following description as “auxiliary power storage device”) is also connected to the generator 1 via the DC-DC converter 4. This auxiliary power storage device 33 is a capacitor or the like, for example.

In the illustrative example of FIG. 1, a switch (e.g., relay) 53 is connected between the DC-DC converter 4 and the auxiliary power storage device 33. For example, the switch 53 is connected to a connection point connecting the DC-DC converter 4 and the switch 52 at one end, and is connected to the auxiliary power storage device 33 at the other end. The switch 53 selects on/off between the DC-DC converter 4 and the auxiliary power storage device 33. On/off of the switch 53 is controlled by the controller 41.

The DC-DC converter 4 also controls charging of this auxiliary power storage device 33. The DC-DC converter 4 charges the auxiliary power storage device 33, by boosting or bucking, as appropriate, the DC voltage from the generator 1, for example, and outputting the resultant voltage to the auxiliary power storage device 33, via the switch 53.

The regeneration power storage device 32 and the auxiliary power storage device 33, for example, can be charged at mutually different timings by the switches 52 and 53. If the controller 41 turns off the switch 52 and turns on the switch 53, the DC-DC converter 4 is able to charge the auxiliary power storage device 33 in that period. Also, if the controller 41 turns on the switch 52 and turns off the switch 53, the DC-DC converter 4 is able to charge the regeneration power storage device 32 in that period. The regeneration power storage device 32 and the auxiliary power storage device 33 can be charged, with DC voltages respectively suitable therefor, by the switches 52 and 53 being exclusively turned on in this way.

The general load 21 and the essential load 22 are, for example, also connected to the main power storage device 31. Power is therefore supplied to the general load 21 and the essential load 22 from the generator 1 or the main power storage device 31. The general load 21 and the essential load 22 are also connected to the regeneration power storage device 32, via the DC-DC converter 4 and the switch 52. Therefore, power is also supplied to the general load 21 and the essential load 22 from the regeneration power storage device 32. The essential load 22 is further connected to the auxiliary power storage device 33 through a path that bypasses the DC-DC converter 4. In the illustrative example of FIG. 1, the auxiliary power storage device 33 is directly connected to the essential load 22. Therefore, power is also supplied to the essential load 22 from the auxiliary power storage device 33.

Note that because the auxiliary power storage device 33 is able to supply power to the essential load 22 without passing via the DC-DC converter 4, power can be supplied to the essential load 22 after the auxiliary power storage device 33 has been charged, even if the switch 53 is maintained in an off state.

The essential load 22 is a load to which power supply is desirably maintained even if power supply from the main power storage device 31 is lost (including loss of power supply due to malfunction of the main power storage device 31), and, for example, a shift-by-wire actuator or an electronic brake force distribution system can be given as examples thereof. In this in-vehicle power supply apparatus 100, power supply to the essential load 22 from the regeneration power storage device 32 and the auxiliary power storage device 33 is possible, even if power supply from the main power storage device 31 is lost.

The general load 21 is a load that does not require backing up by the auxiliary power storage device 33, and is an in-vehicle air-conditioner, for example. Because the general load 21 is a well-known load and does not have a characteristic feature in the present embodiment, a detailed description thereof is omitted. When power supply from the main power storage device 31 is lost, power supply to the general load 21 may be stopped. For example, power supply to the general load 21 can be stopped, by stopping the operation of the DC-DC converter 4.

According to the abovementioned vehicle power supply apparatus, the DC-DC converter 4 is provided in correspondence with both the regeneration power storage device 32 and the auxiliary power storage device 33. Therefore, the DC-DC converter 4 is able to charge both the regeneration power storage device 32 and the auxiliary power storage device 33. Therefore, manufacturing cost can be reduced, compared with the case where a dedicated charging circuit is provided for each of the regeneration power storage device 32 and the auxiliary power storage device 33.

Also, the capacity of the regeneration power storage device 32 is larger than the capacity of the auxiliary power storage device 33, for example. Note that when the power storage device is a capacitor, it is comprehensible that the above capacity is the electric charge amount at the time that charging is completed, for example. Also, in the case where the power storage device is a cell, it is comprehensible that the above capacity is the ampere-hour at the time that charging is completed, for example. The current supply capability of the DC-DC converter 4 is selected in correspondence with the regeneration power storage device 32 which has a large capacity. Therefore, the DC-DC converter 4 is able to output a larger current with respect to the capacity of the auxiliary power storage device 33, and is able to rapidly charge the auxiliary power storage device 33.

Charging Operation

The auxiliary power storage device 33 is connected to the essential load 22 through a path that bypasses the DC-DC converter 4. In the illustrative example of FIG. 1, the auxiliary power storage device 33 is directly connected to the essential load 22. Therefore, power supply to the essential load 22 is possible, even if the auxiliary power storage device 33 is separated from the DC-DC converter 4 after charging. Therefore, the switch 53 may be turned off after the auxiliary power storage device 33 has been charged. Also, in the case where the auxiliary power storage device 33 only supplies power at times when the main power storage device 31 is lost, there is little need to charge the auxiliary power storage device 33 while the vehicle is travelling, and the switch 53 may be mainly maintained in an off state while the vehicle is travelling, after the auxiliary power storage device 33 has been charged.

On the other hand, while the vehicle is travelling, the DC-DC converter 4 is used at both the time of charging and the time of discharging the regeneration power storage device 32, by storing regenerative power in the regeneration power storage device 32 or using the stored power. Therefore, the switch 52 is desirably maintained mainly in an on state while the vehicle is travelling, regardless of the charging state of the regeneration power storage device 32.

Because there is an opportunity for the regeneration power storage device 32 to be charged while the vehicle is travelling, the auxiliary power storage device 33 is desirably charged prior to the regeneration power storage device 32, or, specifically, before the vehicle starts traveling. It is therefore desirable that the controller 41 respectively turns on/off the switches 52 and 53, after respectively turning off/on the switches 52 and 53. Specifically, the auxiliary power storage device 33 is charged by respectively turning off/on the switches 52 and 53, and, thereafter, the switches 52 and 53 are respectively turned on/off. The regeneration power storage device 32 can thereby be charged and discharged while the vehicle is travelling, while completing charging of the auxiliary power storage device 33 and readying power supply to the essential load 22.

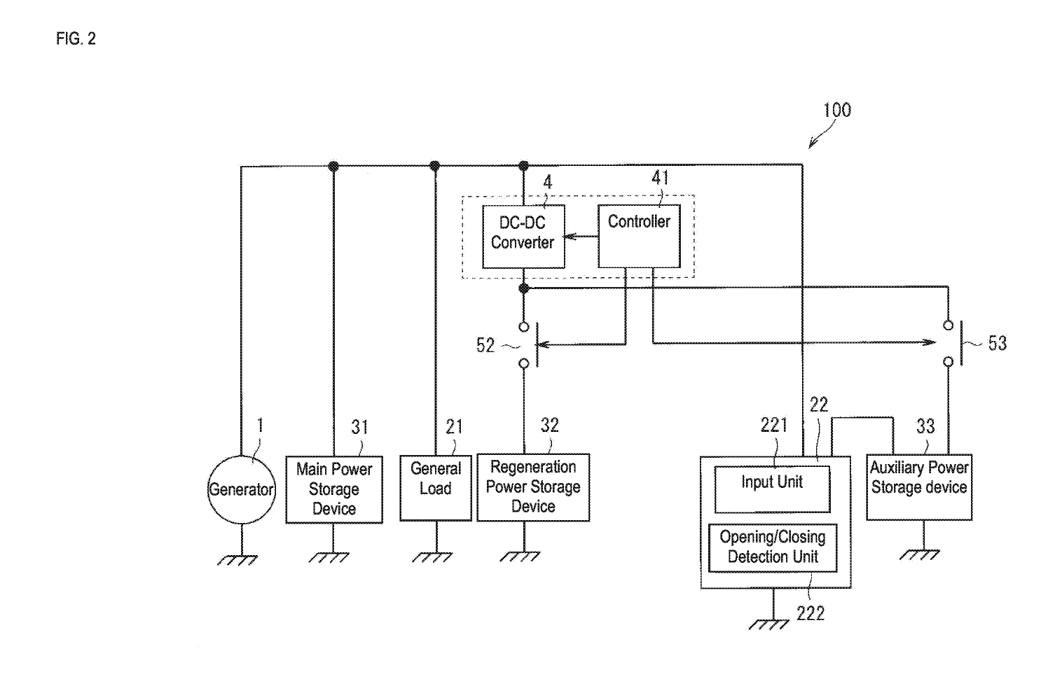

Next, an example of the trigger for respectively turning off/on the switches 52 and 53 will be described. The vehicle includes an input unit (e.g., ignition key) for a user to input an instruction to start the vehicle (e.g., engine start instruction), or an opening/closing detection unit that detects opening/closing of a door of the vehicle. In the illustrative example of FIG. 2, an input unit 221 and an opening/closing detection unit 222 are displayed as an example of the essential load 22. It is, however, comprehensible that at least one of these units is the general load 21.

The instruction to start the vehicle is given before the vehicle starts traveling, and the door is opened in order for the driver to get into the vehicle before the vehicle starts traveling. Therefore, these events can be employed as the abovementioned trigger. Note that the input unit 221 notifies the controller 41 that the vehicle start instruction has been input, and the opening/closing detection unit 222 notifies the controller 41 that the door has been opened.

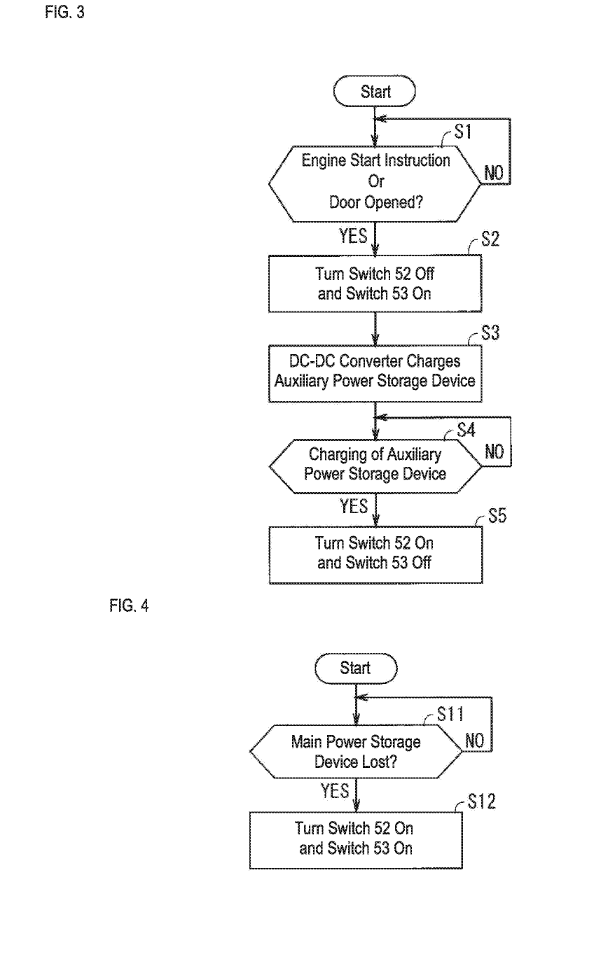

FIG. 3 is a diagram showing an example of the operation of the controller 41. First, at step S1, the controller 41 judges whether the engine starting instruction has been input or whether the door has been opened.

When it is judged in the negative at step S1, step S1 is executed again. When it is judged in the affirmative at step S1, the controller 41, at step S2, turns off the switch 52 and turns on the switch 53. Also, at step S3, the controller 41 controls the DC-DC converter 4, and causes the DC-DC converter 4 to output a DC voltage appropriate for charging the auxiliary power storage device 33.

Next, at step S4, the controller 41 judges whether charging of the auxiliary power storage device 33 is completed. For example, when a detection unit that detects the charging rate of the auxiliary power storage device 33 is provided, and the charging rate exceeds a reference value, it may be judged that charging is completed.

In the case where it is judged in the negative at step S4, step S4 is executed again. In the case where it is judged in the affirmative at step S4, the controller 41, at step S5, turns on the switch 52 and turns off the switch 53. Thereafter, the controller 41, at times when the vehicle is decelerating, for example, causes the DC-DC converter 4 to boost or buck the DC voltage of the generator 1 and to output an appropriate DC voltage for charging of the regeneration power storage device 32. Also, the controller 41, at times when the vehicle is decelerating, for example, causes the DC-DC converter 4 to boost or buck the end-to-end voltage of the regeneration power storage device 32 and to output DC currents suitable for the general load 21 and the essential load 22.

Loss of Power Supply from Power Storage Device

When power supply from the main power storage device 31 is lost, the switches 52 and 53 may be controlled as follows. FIG. 4 is a flowchart showing an example of the operation of the controller 41. At step S11, the controller 41 judges whether power supply from the main power storage device 31 has been lost. Loss of the main power storage device 31 can be detected as follows, for example. For example, when a voltage detection unit that detects the DC voltage of the main power storage device 31 is provided, and the DC voltage of the main power storage device 31 is smaller than, for example, a predetermined anomaly reference value, loss of the main power storage device 31 can be detected.

When it is judged in the negative at step S11, step S11 is executed again. When it is judged in the affirmative at step S11, the controller 41, at step S12, turns on both of the switches 52 and 53.

The regeneration power storage device 32 is thereby able to supply power to the essential load 22, via the switches 52 and 53 and the auxiliary power storage device 33, while bypassing the DC-DC converter 4. This is desirable in terms of being able to avoid the following situations. Power supply from the main power storage device 31 is lost when a short circuit occurs between the DC-DC converter 4 and the essential load 22. In this case, the DC-DC converter 4 is not able to appropriately output a DC voltage to the essential load 22. Therefore, the regeneration power storage device 32 is not able to supply power to the essential load 22 via the DC-DC converter 4. However, by turning on both of the switches 52 and 53, the regeneration power storage device 32 is able to supply power to the essential load 22 via the auxiliary power storage device 33, while bypassing the DC-DC converter 4. Therefore, power can be appropriately supplied to the essential load 22.

Power can be supplied to the essential load 22 not only from the auxiliary power storage device 33 but also from the regeneration power storage device 32, at times when power supply from the main power storage device 31 is lost. Therefore, the stability of power supply can be improved.

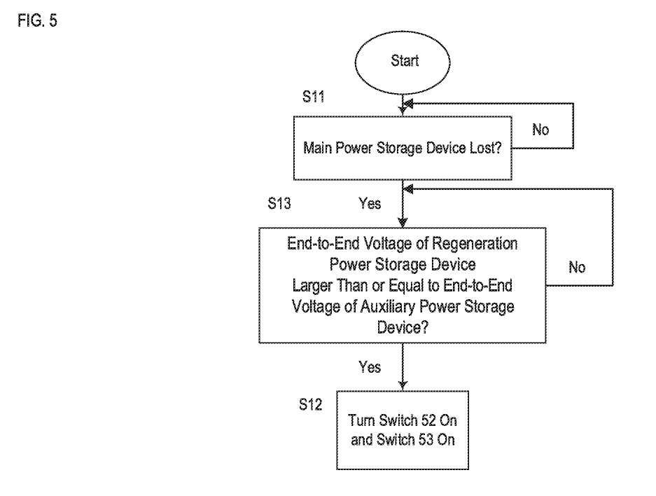

FIG. 5 is a flowchart showing an example of the operation of the controller 41. Compared with FIG. 4, the controller 41 further executes step S13. Step S13 is executed between steps S11 and S12. At step S13, the controller 41 judges whether the end-to-end voltage of the regeneration power storage device 32 is larger than or equal to the end-to-end voltage of the auxiliary power storage device 33. The end-to-end voltages are detected by providing a voltage detection unit in each of the regeneration power storage device 32 and the auxiliary power storage device 33, for example. The magnitude of the end-to-end voltages can be discriminated using a comparator.

Incidentally, the end-to-end voltage of the regeneration power storage device 32 decreases due to discharging and increase due to charging. In particular, in the case where a capacitor is employed as the regeneration power storage device 32, the end-to-end voltage changes proportional to the electric charge. Therefore, the amount of change in this end-to-end voltage increases, compared with the case where a storage cell is employed. For example, at the time of charging, the regeneration power storage device 32 can be charged to a higher voltage (e.g., 16 V) than the DC voltage (e.g., 12 V) of the generator 1, and, at the time of discharging, the regeneration power storage device 32 can be discharged to a lower voltage (e.g., 7 V) than the DC voltage of the generator 1.

On the other hand, in the case where power supply of the main power storage device 31 is functioning, the auxiliary power storage device 33 need not be discharged. For example, a diode is provided between the main power storage device 31 and the essential load 22, and a diode is provided between the auxiliary power storage device 33 and the essential load 22. The forward direction of these diodes is toward the essential load 22. In this structure, if the end-to-end voltage of the auxiliary power storage device 33 is set slightly smaller than the voltage (e.g., 12 V) of the main power storage device 31, power is supplied to the essential load 22 from the main power storage device 31 rather than the auxiliary power storage device 33. Therefore, when power supply of the main power storage device 31 is functioning, the auxiliary power storage device 33 is not discharged. In this case, the end-to-end voltage of the auxiliary power storage device 33 is substantially constant.

Alternatively, for example, in the case where a storage cell (e.g., lithium ion cell) is employed as the auxiliary power storage device 33, the amount of change in the end-to-end voltage is small compared with a capacitor. For example, the auxiliary power storage device 33 is charged with a comparable voltage (e.g., 12 V) to the DC voltage of the generator 1.

In such a case, at the time of executing step S13, the end-to-end voltage of the regeneration power storage device 32 may be smaller than the end-to-end voltage of the auxiliary power storage device 33. The auxiliary power storage device 33 discharges to the regeneration power storage device 32 when both of the switches 52 and 53 are turned on at this time. This current does not contribute to power supply to the essential load 22, and is thus not desirable.

In view of this, in the case where it is judged at step S13 that the end-to-end voltage of the regeneration power storage device 32 is smaller than the end-to-end voltage of the auxiliary power storage device 33, step S13 is executed again, without executing step S12. When it is then judged at step S13 that the end-to-end voltage of the regeneration power storage device 32 is larger than or equal to the end-to-end voltage of the auxiliary power storage device 33, step S12 is executed.

According to this configuration, discharging from the auxiliary power storage device 33 to the regeneration power storage device 32 can be prevented, and discharged current contributes to power supply to the essential load 22.

Note that a plurality of regeneration power storage devices 32 may be provided, and a plurality of auxiliary power storage devices 33 may be provided.

The configurations described in the above embodiments and modifications can be combined as appropriate, as long as there are no mutual inconsistencies.

Although the invention has been described above in detail, the abovementioned description is, in all respects, illustrative, and the invention is not limited thereto. It should be understood that numerous modifications that are not illustrated can be conceived without departing from the scope of the invention.

1. An in-vehicle power supply apparatus comprising:
a bidirectional converter;
a first power storage device that is charged via the converter and discharges to a load via the converter;
a first switch that selects on/off between the converter and the first power storage device;
a second power storage device that is charged via the converter and discharges to the load through a path that bypasses the converter; and
a second switch that selects on/off between the converter and the second power storage device.

2. The in-vehicle power supply apparatus according to claim 1, wherein the first switch and the second switch are respectively turned on/off, after being respectively turned off/on.

3. The in-vehicle power supply apparatus according to claim 2,
wherein a vehicle in which the in-vehicle power supply apparatus is to be mounted includes an input unit to which an instruction to start the vehicle is input, and an opening/closing detection unit that detects opening/closing of a door,
when the start instruction is input or when the door opens, the first switch and the second switch are respectively turned off/on.

4. The in-vehicle power supply apparatus according to claim 1, comprising:
a main power storage device that is connected to the load,
wherein, when a voltage of the main power storage device is smaller than an anomaly reference value, and a voltage of the first power storage device is larger than or equal to a voltage of the second power storage device, the first switch and the second switch are turned on.

5. The in-vehicle power supply apparatus according to claim 2, comprising:
a main power storage device that is connected to the load,
wherein, when a voltage of the main power storage device is smaller than an anomaly reference value, and a voltage of the first power storage device is larger than or equal to a voltage of the second power storage device, the first

6. The in-vehicle power supply apparatus according to claim to 3, comprising:
a main power storage device that is connected to the load,
wherein, when a voltage of the main power storage device is smaller than an anomaly reference value, and a voltage of the first power storage device is larger than or equal to a voltage of the second power storage device, the first
